(19) United States
(12) Patent Application Publication
(10) Pub. No.: US 2020/0127373 A1
(43) Pub. Date: Apr. 23, 2020

(54) BOTTOM-UP RADAR SENSOR RADOME CONSTRUCTION

(71) Applicant: GM GLOBAL TECHNOLOGY OPERATIONS LLC, Detroit, MI (US)

(72) Inventors: Igal Bilik, Rehovot (IL); Leon Garnett, Shoham (IL)

(73) Assignee: GM GLOBAL TECHNOLOGY OPERATIONS LLC, Detroit, MI (US)

(21) Appl. No.: 16/163,911

(22) Filed: Oct. 18, 2018

(51) Int. Cl. H01Q 1/42; G01S 7/03; G01S 13/93

(52) U.S. Cl. CPC H01Q 1/422; G01S 2007/027; G01S 13/931; G01S 7/03

(57) ABSTRACT

Radar systems are provided for mobile platforms that include, in one embodiment, an antenna and a radome. The radome surrounds the antenna, and includes a plurality of transition layers each having a different respective permittivity. The respective permittivities of each of the transition layers are inversely related to a distance from the respective one of the transition layers to the antenna, generating a permittivity gradient for the radome.

### TECHNICAL FIELD

The technical field generally relates to the field of radar systems, and, more specifically, to radome construction for radar systems, for example for implementation in vehicles.

### INTRODUCTION

Many vehicles include radar systems. Such radar systems of vehicles, as well as other radar systems, include an antenna and a radome as a protective structure for the antenna. However, in certain situations radomes may cause interference with radar signals due to the higher frequencies used in modern automotive radars.

Accordingly, it may be desirable to provide radar systems with radome structures that do not introduce additional interference, for example for implementation in vehicles.

Furthermore, other desirable features and characteristics of the present invention will become apparent from the subsequent detailed description and the appended claims, taken in conjunction with the accompanying drawings.

### SUMMARY

In accordance with an exemplary embodiment, a radar system is provided that includes an antenna and a radome. The radome surrounds the antenna, and includes a plurality of transition layers each having a different respective permittivity. The respective permittivities of each of the transition layers are inversely related to a distance from the respective one of the transition layers to the antenna, generating a permittivity gradient for the radome.

Also in one embodiment, the plurality of transition layers are each made of a different dielectric material.

Also in one embodiment, the radar system includes a plurality of antennas; and the plurality of transition layers include: a first transition layer including isolating material that is disposed between the plurality of antennas; and a plurality of additional transition layers surrounding the first transition layer.

Also in one embodiment, the plurality of additional transition layers include one or more lenses.

Also in one embodiment, the plurality of additional transition layers include: an outer transition layer in contact with an outside region that is disposed outside the radome; and a plurality of intermediate transition layers disposed between the first transition layer and the outer transition layer.

Also in one embodiment, the outer transition layer includes a conical lens; and the plurality of intermediate transition layers include one or more flat lenses.

Also in one embodiment, the radar system is configured for implementation on a mobile platform.

In another exemplary embodiment, a mobile platform is provided that includes a body and a radar system. The radar system is formed on the body, and includes an antenna and a radome. The radome surrounds the antenna, and includes a plurality of transition layers each having a different respective permittivity. The respective permittivities of each of the transition layers are inversely related to a distance from the respective one of the transition layers to the antenna, generating a permittivity gradient for the radome.

Also in one embodiment, the plurality of transition layers are each made of a different dielectric material.

Also in one embodiment, the radar system includes a plurality of antennas; and the plurality of transition layers include: a first transition layer including isolating material that is disposed between the plurality of antennas; and a plurality of additional transition layers surrounding the first transition layer.

Also in one embodiment, the plurality of additional transition layers include one or more lenses.

Also in one embodiment, the plurality of additional transition layers include: an outer transition layer in contact with an outside region that is disposed outside the radome; and a plurality of intermediate transition layers disposed between the first transition layer and the outer transition layer.

Also in one embodiment, the outer transition layer includes a conical lens; and the plurality of intermediate transition layers include one or more flat lenses.

Also in one embodiment, the mobile platform includes a vehicle.

Also in one embodiment, the mobile platform includes an automobile.

In another exemplary embodiment, a method is provided that includes: obtaining an antenna for a radar system; and forming a plurality of transition layers surrounding the antenna, forming a radome, with each of the plurality of transition layers having a different respective permittivity, wherein the respective permittivities of each of the transition layers are inversely related to a distance from the respective one of the transition layers to the antenna, generating a permittivity gradient for the radome.

Also in one embodiment, the forming of the transition layers includes forming the transition layers via injection molding.

Also in one embodiment, the forming of the transition layers includes forming the transition layers via three-dimensional printing.

Also in one embodiment, the forming of the transition layers includes forming each of the transition layers with a different dielectric material.

Also in one embodiment, the obtaining of the antenna includes obtaining a plurality of antennas for the radar system; and the forming of the plurality of transition layers includes: forming a first transition layer including isolating material between the plurality of antennas; and forming a plurality of additional transition layers surrounding the first transition layer.

### DESCRIPTION OF THE DRAWINGS

The present disclosure will hereinafter be described in conjunction with the following drawing figures, wherein like numerals denote like elements, and wherein:

FIG. 1 is a functional diagram of a vehicle, namely an automobile, that includes a radar system having an antenna and a radome that includes a plurality of transition layers forming a permittivity gradient between the antenna and an outside region, in accordance with exemplary embodiments;

FIG. 2 is a schematic representation of the radar system of FIG. 1, in accordance with exemplary embodiments;

FIG. 3 is a graphical representation of the permittivity gradient of the radome of the radar system of FIGS. 1 and 2;

FIG. 4 is an additional schematic representation of the radar system of FIGS. 1 and 2, depicted with specific transition layers;

FIG. 5 is an additional schematic representation of the radar system of FIGS. 1, 2, and 4, depicted with lenses incorporated into the specific transition layers of FIG. 4, in accordance with exemplary embodiments;

FIG. 6 is a graphical representation of the permittivity gradient of the radome of the radar system of FIG. 5, in accordance with exemplary embodiments;

FIG. 7 is a schematic representation of an implementation of the radar system of FIG. 5 in connection with a flat lens, in accordance with exemplary embodiments;

FIG. 8 is a flowchart of a process for generating a radar system that includes a radar and a radome that includes a plurality of transition layers forming a permittivity gradient between the antenna and an outside region, and that can be incorporated with the radar system of FIG. 1, including the embodiments of FIGS. 2, 4, 5, and 7, in accordance with exemplary embodiments; and

FIG. 9 provides a schematic illustration of utilizing separate and shared regions for forming transition layers for multiple antennas using the process of FIG. 9, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

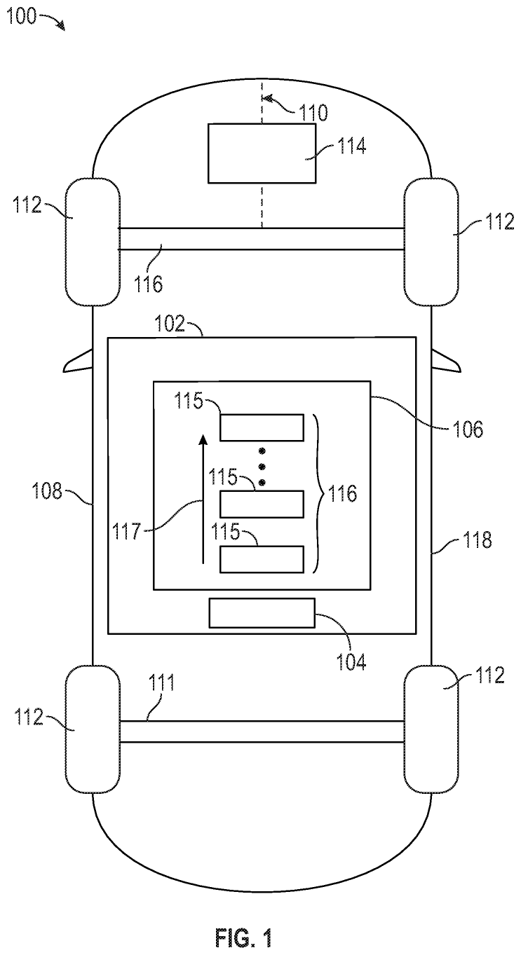

FIG. 1 illustrates a vehicle 100 having a radar system 102, in accordance with exemplary embodiments. As described in greater detail below, the radar system 102 includes one or more antennas 104 and a radome 106 having a permittivity gradient 117.

As depicted in FIG. 1, in certain embodiments, the vehicle 100 comprises an automobile. It will be appreciated that the radar system 102 described herein may be implemented in any number of different types of vehicles and/or platforms. For example, in various embodiments, the vehicle 100 may comprise any number of different types of automobiles (e.g., taxi cabs, vehicle fleets, buses, sedans, wagons, trucks, and other automobiles), other types of vehicles (e.g., marine vehicles, locomotives, aircraft, spacecraft, and other vehicles), and/or other mobile platforms, and/or components thereof. In addition, in various embodiments, the radar system 102 may be a stand along system, and/or may be implemented in connection with any number of other different types of systems and/or devices.

In various embodiments, the vehicle 100 includes a body 108 that is arranged on a chassis 110. The body 108 substantially encloses other components of the vehicle 100. The body 108 and the chassis 110 may jointly form a frame. The vehicle 100 also includes a plurality of wheels 112. The wheels 112 are each rotationally coupled to the chassis 110 near a respective corner of the body 108 to facilitate movement of the vehicle 100. In one embodiment, the vehicle 100 includes four wheels 112, although this may vary in other embodiments (for example for trucks and certain other vehicles).

A drive system 114 is mounted on the chassis 110, and drives the wheels 112, for example via axles 111. The drive system 114 preferably comprises a propulsion system. In certain exemplary embodiments, the drive system 114 comprises an internal combustion engine and/or an electric motor/generator, coupled with a transmission thereof. In certain embodiments, the drive system 114 may vary, and/or two or more drive systems 114 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In the depicted embodiment, the radar system 102 includes one or more above-referenced antennas 104 along with the above-referenced radome 106. In various embodiments, the radome 106 comprises a plurality of transition layers 115 that collectively form a transition between the antenna(s) 104 and an outside region 118 that is disposed outside the radome 106 (e.g., outside or ambient air that is disposed outside the body 108 of the vehicle 100, in certain embodiments). The plurality of transition layers 115 enclose and provide physical protection for the antenna(s) 104, with potentially reduced interference with signals from the radar system 102.

In various embodiments, each of the plurality of transition layers 115 has a different respective permittivity and varying thicknesses. In certain embodiments, each of the transition layers 115 is formed of a different dielectric material, thereby resulting in the different respective permittivities. In certain embodiments, the transition layers 115 are made of different plastic materials. In various embodiments, different types of metals may be utilized.

Also in various embodiments, the respective permittivities of each of the transition layers 115 are inversely related to a distance from the respective one of the transition layers 115 to the antenna(s) 104. Thus, in various embodiments, transition layers 115 that are disposed relatively closer to the antenna(s) 104 (and farther from the outside region 118) have relatively greater permittivity as compared with transition layers 115 that are disposed relatively farther from the antenna(s) 104 (and closer to the outside region 118). As a result, the above-mentioned permittivity gradient 117 exists with gradual decreasing permittivity between the antenna(s) 104 and the outside region 118, in certain embodiments. In various embodiments, the permittivity gradient 117 is continuous (or at least substantially continuous), as a result of gradual or continuous changes in permittivity across adjoining transition layers 115. The permittivity gradient 117 provides potentially reduced interference with signals from the radar system 102 as well as potential heat mitigation for the radar system 102.

In various embodiments, the transition layers 115 may be established as set forth above using iterative design processes with different thicknesses for the layers. For example, in certain embodiments, metals can be regarded as having an infinite permittivity, whereas air has a relative permittivity of very close to unity (relative permittivities are ratios of the permittivity of vacuum). In various embodiments, the different dielectrics are chosen such that they can provide a gradient between infinity and one. In various embodiments, approximations may be utilized, for example because there must be a dielectric discontinuity for the very first layer, and thus trials may be utilized for choosing the very first layers in certain embodiments. Also in certain embodiments, a discontinuity may also be apparent in the solid-air interface. In various embodiments, the different dielectrics are chosen in order to minimize these discontinuities as much as possible within physical limitations of existing materials. In various embodiments, different layer thicknesses may be selected based on the chosen dielectric gradient, which may involve an iterative design process with antenna simulations with the layered radome, in order to arrive at optimal transition layers 115 as set forth above.

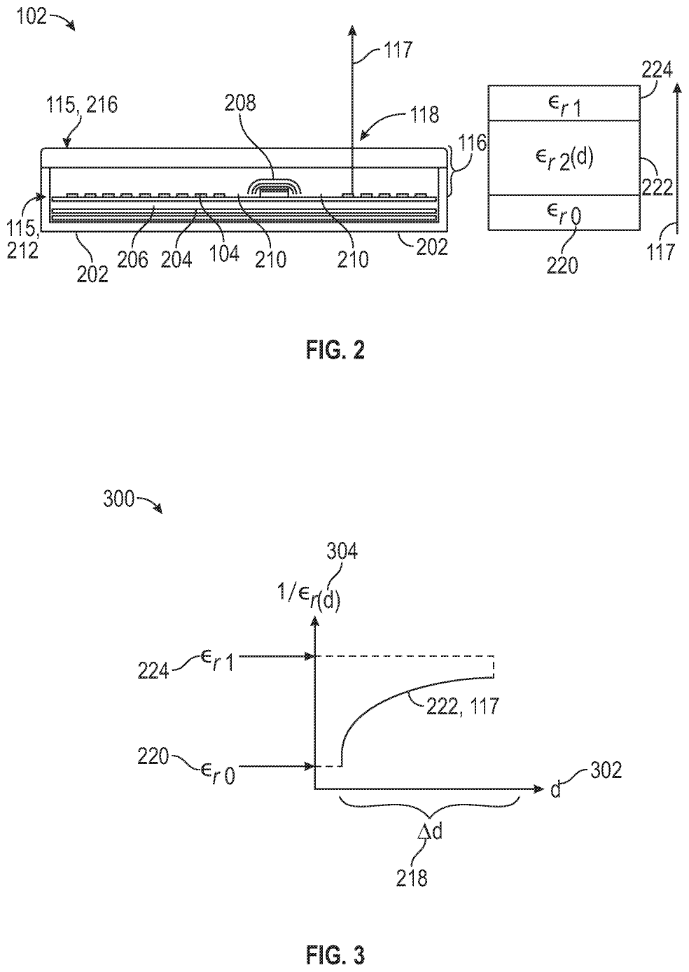

It is noted that while the radar system 102 is depicted in FIG. 1 as being part of an automobile, it will be appreciated that this may vary in other embodiments. For example, as mentioned above, in various embodiments, the radar system 102 of FIG. 1, as well as the system(s) depicted in FIGS. 2-9 and described throughout this Application may installed be disposed within any number of other different types of vehicles and/or other mobile platforms, and/or separate and/or independent from any automobiles, vehicles, and/or other mobile platforms.

FIG. 2 is a schematic representation of the radar system 102 of FIG. 1, in accordance with exemplary embodiments. As depicted in FIG. 2, in various embodiments, the radar system 102 includes above-referenced antennas 104 and the above-referenced transition region 116 of FIG. 1, as well as an outer shell 202 (e.g., made of metal), printed circuit boards (PCBs) 204, a substrate layer 206, and a heatsink 208.

As depicted in FIG. 2, in various embodiments, the transition layers 115 of the transition region 116 include a first transition layer 212, one or more intermediate transition layers 214, and an outer transition layer 216. Also in various embodiments, the first transition layer 212 includes regions between the various antennas 104, including isolation material 210 between the antennas 104. In various embodiments, the isolation material 210 separates the antennas 104 from one another, and includes radar-absorption material. In certain embodiments, the isolation material 210 may include one or more materials that are regarded as radiation absorbents and are typically tailored and optimized for a specific range of frequencies. In certain embodiments, these include dielectrics with lossy properties, and that can be painted or molded, if chemically formulated for such a purpose (e.g., these may include one or more paints that can be used for conventional painting of surfaces or to be absorbed into foam blocks that subsequently act as radar absorbing blocks, in certain embodiments).

Also in various embodiments, the outer transition layer 216 is disposed adjacent to the outside region 118 (i.e., outside the radar system 102). In addition, in various embodiments, the intermediate transition layers 214 are disposed between the first transition layer 212 and the outer transition layer 216. Similar to the discussion above, in various embodiments, the respective permittivity of the transition layers 115 varies, and specifically, decreases from the first transition layer 212 to the outer transition later 216, generating the permittivity gradient 117 between the antennas 104 and the outside region 118. In various embodiments, the different permittivities are generated by using different dielectric materials for the different respective transition layers 115. In various embodiments, the continuous transition refers to a proposed guideline and/or approximation. In certain embodiments, a staggered permittivity order may be utilized (e.g., the value may go up for a layer and the continue in the gradient, in certain embodiments). As noted above, in various embodiments, the permittivity gradient 117 is continuous (or at least substantially continuous), as a result of gradual or continuous changes in permittivity across adjoining transition layers 115. In certain embodiments, the overall transition along the gradient is from metal to air, within the layers. In various embodiments, the continuity of the gradient may be maintained (or approximately maintained), and can also incorporate other dielectric structures within, such as with regards to lenses, for example as discussed further below.

As illustrated in FIG. 2, in various embodiments, the antennas 104 have a first permittivity 220 (or highest permittivity); the outside region 118 has a second permittivity 224 (or lowest permittivity), and the various transition layers 115 (e.g., the first transition layer 212, the intermediate transition layers 214, and the outer transition layer 216) have different respective permittivities 222 in between. In various embodiments, each of the respective permittivities 222 are less than the first permittivity 220 and greater than the second permittivity 224. In addition, in various embodiments, each of the transition layers 212, 214, 216 have different respective permittivites 222 from one another that are inversely related to their respective distances from the antennas 104, thereby generating the permittivity gradient 117 between the antennas 104 and the outside region 118. In various embodiments, different thicknesses of the layers may be utilized with respect to respective permittivities. In certain embodiments, the thicknesses may be chosen with respect to the antenna design (e.g., frequency in particular), similar to conventional radome design. However, in certain embodiments, the higher permittivity layers are relatively thinner as a secondary objective, but not in a manner that limits the primary objective of the gradient.

FIG. 3 is a graphical representation 300 of the permittivity gradient 117 of the radome 106 of the radar system 102 of FIGS. 1 and 2, in accordance with various embodiments. In the graphical representation 300 of FIG. 3, the x-axis 302 represents distance “d” (from the antenna), and the y-axis 304 represents an inverse of permittivity, or 1/ϵ_{r(d)}. As depicted in FIG. 3, in certain embodiments, the permittivity gradient 117 represents a smooth transition in permittivity from the antennas 104 (i.e., first permittivity 220 as denoted in FIG. 3, or Eᵣ₀) to the outside region 118 (e.g., air surrounding the radome 106) (i.e., second permittivity 224 as denoted in FIG. 3, or Eᵣ₁), via the various transition layers 115. It will be understood that, in FIG. 3, the Epsilonᵣ₀ (Eᵣ₀) is an approximation, for example because metals ideally have an infinite permittivity value (and therefore this is depicted as a limit in various embodiments).

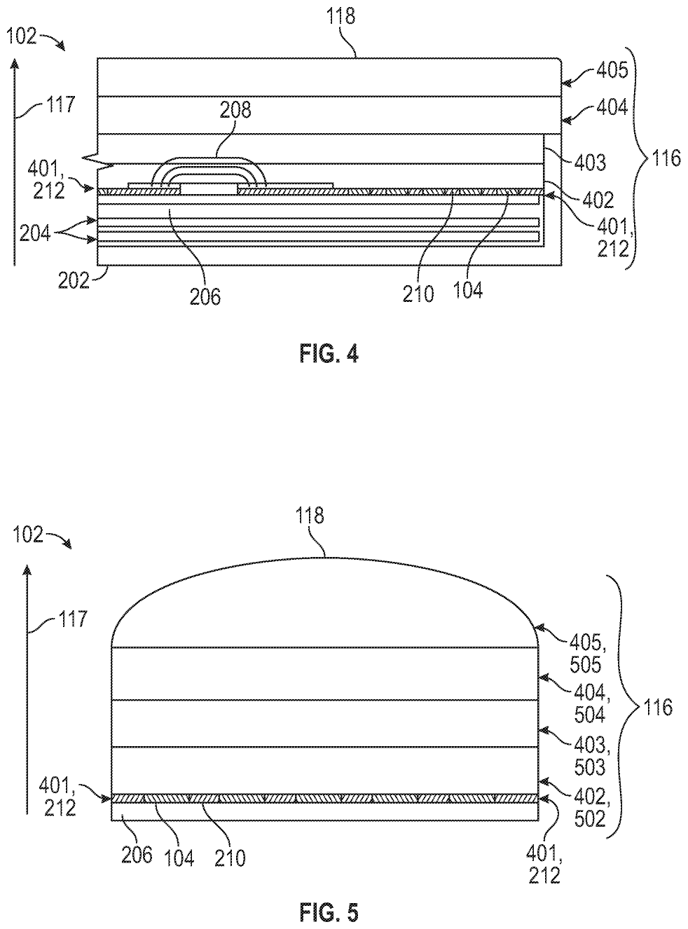

FIG. 4 is an additional schematic representation of the radar system 102 of FIGS. 1 and 2, depicted with specific transition layers 401-405, in accordance with exemplary embodiments. For example, as depicted in FIG. 4, in certain embodiments, a first transition layer 401 corresponds to the first transition layer 212 of FIG. 2, including the isolation material between the antennas 104. Also in various embodiments, an outer transition layer 405 corresponds to the outer transition layer 216 of FIG. 2, and is in contact with the outside region 118 (e.g., air surrounding the radome 106). In addition, also as depicted in FIG. 4, in various embodiments, there are a plurality of additional transition layers 402, 403, and 404 between the first transition layer 401 and the outer transition layer 405 (e.g., in various embodiment, transition layers 402, 403, and 404 collectively comprise the intermediate transition layers 214 of FIG. 2). In various embodiments, the respective permittivities gradually decrease in sequence from each of the respective transition layers 401-405, thereby generating the permittivity gradient 117 between the antennas 104 and the outside region 118.

FIG. 5 is an additional schematic representation of the radar system 102 of FIGS. 1, 2, and 4, depicted with lenses incorporated into the specific transition layers 402-405 of FIG. 4, in accordance with exemplary embodiments. Specifically, in certain embodiments depicted in FIG. 5, transition layers 402-405 each comprise respective lenses 502-505. Specifically, in various embodiments as depicted in FIG. 5: (i) intermediate transition layer 402 comprises a first flat lens 502; (ii) intermediate transition layer 403 comprises a second flat lens 503; (iii) intermediate transition layer 404 comprises a third flat lens 504; and (iv) outer transition layer 405 comprises a conical lens 505. In various embodiments, the lenses 502-505 are utilized to focus or disperse the signals as desired.

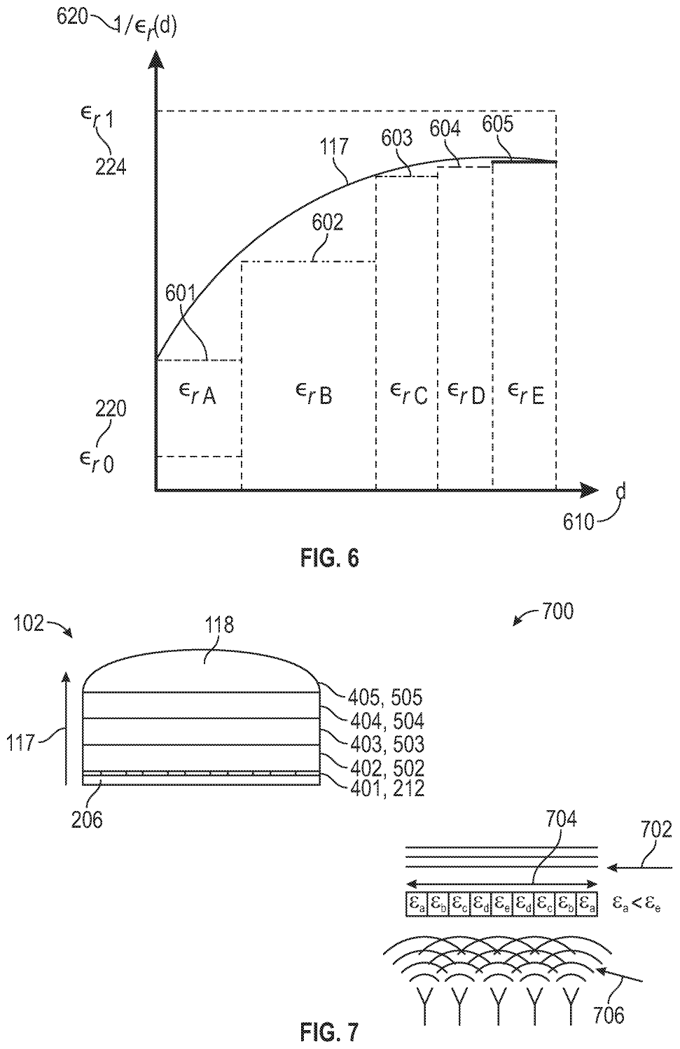

FIG. 6 is a graphical representation of the permittivity gradient 117 of the radome 106 of the radar system 102 of FIG. 5, in accordance with exemplary embodiments. In the graphical representation 600 of FIG. 6, the x-axis 302 represents distance “d” (from the antenna), and the y-axis 304 represents the inverse of permittivity, or 1/ϵ_{r(d)}. Specifically, as depicted in FIG. 6, in certain embodiments, the permittivity gradient 117 represents a smooth transition in permittivity from the antennas 104 (i.e., first permittivity 220, or Eᵣ₀) to the outside region 118 118 (e.g., air surrounding the radome 106), via the various transition layers 115. For example, in certain embodiments in accordance with the example of FIG. 6, the permittivities gradually decrease (i.e., the inverse of the permittivities increases) from the first permittivity 220 (i.e., Eᵣ₀) of the antennas 104 to the second permittivity 224 (i.e., Eᵣ₁) of the outside region 118 (e.g., the air surrounding the radome 106), via respective intermediate permittivities 601 (corresponding to transition layer 501 of FIG. 1), 602 (corresponding to lens 502 of FIG. 1), 603 (corresponding to lens 503 of FIG. 1), 604 (corresponding to lens 504 of FIG. 1), 605 (corresponding to lens 505 of FIG. 1), and so on. By way of additional clarification, in various embodiments, the gradient 117 is a function of a layer thickness in conjunction with the permittivity value chosen per layer. Also in various embodiments, similar to the discussion above, a “(Metal)” label may appear as a lower bounding limit

FIG. 7 is a schematic representation of an implementation of the radar system 102 of FIG. 5, including positioning of lenses 502-505 thereof, utilizing a flat lens structure, in accordance with exemplary embodiments. For example, as depicted in FIG. 7, via a sequence of illustrations 700, in various embodiments, signals travelling through one or more flat lenses (e.g. lens 502) have a modified wave front 702 after travelling through the lens, due to a dielectric variance 704 that exists within the lens layer to form the lens. Also in various embodiments, as depicted in FIG. 7, radiation patterns 706 result from the transmission array as a result of antennas that may be in direct contact with the lens. As depicted in FIG. 7, the aggregate result of the signals travelling through the various layers (e.g., including various lenses) of the radar system 102 is the gradient 117 depicted in FIG. 7 and described above.

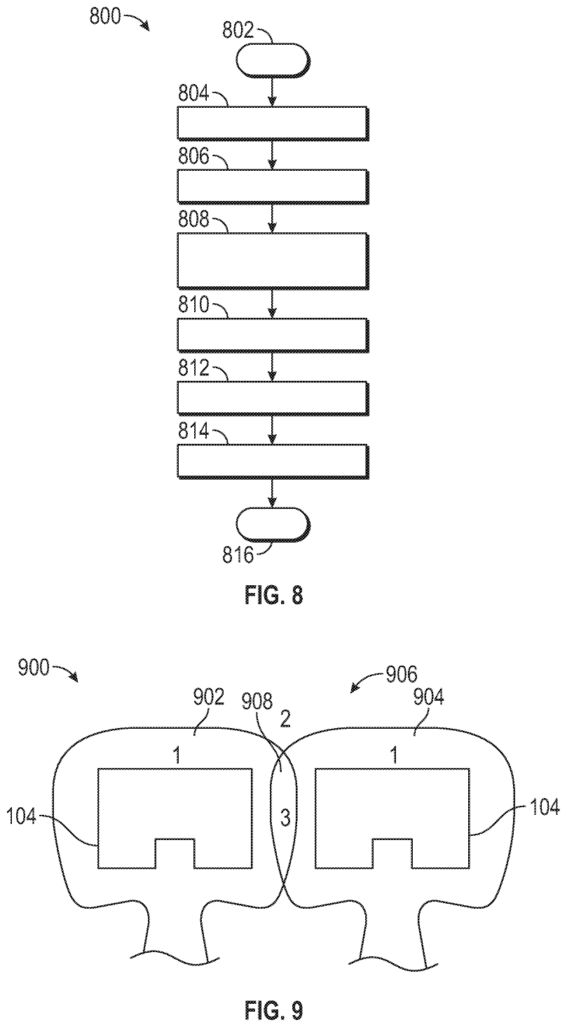

FIG. 8 depicts a flowchart of a process 800 for generating a radar system that includes a radar and a radome that includes a plurality of transition layers forming a gradient between the radar and an outside region, and that can be incorporated with the radar system 102 of FIG. 1, including the embodiments of FIGS. 2, 4, 5, and 7, in accordance with exemplary embodiments.

As depicted in FIG. 8, the process 800 begins at 802. For example, in certain embodiments, the process 800 begins when the radar system 102 is. ready to be finalized, in terms of production phases, and the unit is ready to be sealed and covered from the antenna side

In various embodiments, antennas are obtained at 804. In various embodiments, antennas corresponding to antennas 104 of FIGS. 1, 2, 4, and 7 are obtained.

Also in various embodiments, a first transition layer is formed at 806. In various embodiments the first transition layer may be dual purpose and may also act as an isolation layer if desired, a first transition layer is formed around the antennas 104 utilizing one or more materials (e.g., corresponding to the first transition layer 212 and the isolation material 210 of FIGS. 2, 4, and 5). In certain embodiments, the first transition layer is formed via injection molding. In certain embodiments, the mold to which the material is to be injected is formed by the radar body and the antennas so that the molded material is never meant to be separated from its mold. In various embodiments, the molding can also be done via reaction injection molding and/or one or more other techniques. In certain other embodiments, the first transition layer is formed via three-dimensional printing. In yet other embodiments, the first transition layer may be formed using a combination of these techniques, and/or using one or more other techniques.

Also in various embodiments, one or more intermediate transition layers are formed at 808. In various embodiments, a plurality of intermediate transition layers are formed beyond the first transition layer (e.g., further from the antennas, with a first intermediate transition layer being adjacent to the first transition layer of 806, and subsequent intermediate transition layers being adjacent to one another and farther still from the antennas, and so on). Also in various embodiments, the intermediate transition layers are made of different dielectric materials than one another (and than the first transition layer), such that respective permittivities decrease as the respective distances from the antennas increase. In certain embodiments, the intermediate transition layers are formed via injection molding. In certain other embodiments, the intermediate transition layers are formed via three-dimensional printing. In yet other embodiments, the intermediate transition layers are formed using one or more combinations of these techniques, and/or using one or more other techniques.

In addition, in various embodiments, an outer (or external) transition layer is formed at 810. In various embodiments, the outer layer is formed between and adjacent to the last intermediate transition layer (e.g., the intermediate transition layer farthest from the antenna) and the outside region 118. Also in various embodiments, the outer transition layer of 810 is made of a different dielectric material than each of the first transition layer of 806 and the intermediate transition layers of 810, such that the permittivity of the outer transition layer is less than the permittivities for each of the other respective transition layers of the radome.

In accordance with various embodiments, the various layers may be formed inside the full body of the radar, so that each layer forms a part of the final sealing of the radome. However, this may vary in other embodiments. In addition, in certain embodiments, a final sealing layer may still be added as part of 812.

With reference to FIG. 9, in various embodiments, multiple antennas 104 are depicted in proximity to one another, along with an outside region 906 surrounding respective radomes for the antennas 104. In various embodiments, the transition layers of 806-810 may be formed either separately for each antenna 104 (e.g., in separate respective regions 902 and 904 of FIG. 9) and/or together with one or more shared regions (e.g., in shared region 908 of FIG. 1).

In addition, in certain embodiments, the radar system is installed on a vehicle (e.g., the vehicle 100 of FIG. 1) at 814. For example, in certain embodiments, the radar system is disposed within or against a fascia of the body 108 of the vehicle 100 at one or more locations of the vehicle 100 of FIG. 1. In certain embodiments, the installing on the vehicle can also include attaching the final layer to a desired position on the vehicle fascia, thus making the fascia the actual final outer layer of the hybrid (layers+vehicle fascia) radome.

Similar to the discussion above, in certain embodiments, installation on a vehicle is not performed, and the radar system is generated separate and independent from any vehicles (e.g., as a stand-alone device and/or for use in connection with any number of other types of devices and/or systems).

Also in certain embodiments, the process 800 terminates at 816 when the radar system is complete. In certain embodiments, per the discussion above, the final layer of the radome can also be a finishing layer or a sort of ‘primer’ to the radar installation onto a vehicle. This can also be used as a solution to a similar challenge often presented by the fascia of the vehicle in the form of a further dielectric-air-dielectric interface between the radome outer layer and the air on the outside of the vehicle. In various embodiments, the radome gradient discussed above can also be incorporated as part of the vehicle installation, for example through chemical bonding the last radome layer and the inner part of the vehicle fascia in certain embodiments.

Accordingly, radar systems, mobile platforms, and methods are provided for radar systems that include an antenna and a radome. In various embodiments, the radome includes various transition layers that are made of different dielectric materials, thereby generating a permittivity gradient from the antennas to an outer region beyond the radome. In various embodiments, the permittivity gradient is a continuous (or approximately continuous) gradient, based on continuous (or approximately continuous) changes in the permittivities of adjoining transition layers. Also in various embodiments, unwanted interference is potentially reduced due to the use of the multiple layers comprising a continuous (or approximately continuous) gradient, instead of gas cavities that are inherent in other types of radomes. In addition, this also provides for potentially improved heat mitigation for the radar system (e.g., due to the replacement of the gas cavities with the continuous gradient which offers a solid phase), as well as potentially improved robustness (e.g., because the radar system and radome are formed into a single, adhered part). In various embodiments, potentially improved sealing is provided for vehicles 100, for example in automotive applications, for example with respect to liquid ingress, IP ratings, and so on. Also in various embodiments, the multiple layers may form, as a by product, an extensive sealing mechanism, and for example that may also include the introduction of a sealant in conjunction with the dielectric layers (and, in certain embodiments, with the dielectric layers also serving as effective sealants).

It will be appreciated that the radar systems and mobile platforms (and components thereof) may vary from those depicted in the Figures and described herein. It will similarly be appreciated that the radar system, and components and implementations thereof, may be installed in any number of different types of platforms (including those discussed above) and/or as a stand-alone system, and may vary from that depicted in FIG. 1 and described in connection therewith, in various embodiments. It will also be appreciated that the processes (and/or subprocesses) disclosed herein may differ from those described herein and/or depicted in FIG. 8, and/or that steps thereof may be performed simultaneously and/or in a different order as described herein and/or depicted in FIG. 8, among other possible variations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A radar system comprising:
an antenna; and
a radome surrounding the antenna, the radome comprising a plurality of transition layers each having a different respective permittivity;
wherein the respective permittivities of each of the transition layers are inversely related to a distance from the respective one of the transition layers to the antenna, generating a permittivity gradient for the radome.

2. The radar system of claim 1, wherein the plurality of transition layers are each made of a different dielectric material.

3. The radar system of claim 1, wherein:
the radar system comprises a plurality of antennas; and
the plurality of transition layers comprise:
a first transition layer comprising isolating material that is disposed between the plurality of antennas; and
a plurality of additional transition layers surrounding the first transition layer.

4. The radar system of claim 3, wherein the plurality of additional transition layers comprise one or more lenses.

5. The radar system of claim 3, wherein the plurality of additional transition layers comprise:
an outer transition layer in contact with an outside region; and
a plurality of intermediate transition layers disposed between the first transition layer and the outer transition layer.

6. The radar system of claim 5, wherein:
the outer transition layer comprises a conical lens; and
the plurality of intermediate transition layers comprise one or more flat lenses.

7. The radar system of claim 1, wherein the radar system is configured for implementation on a mobile platform.

8. A mobile platform comprising:
a body; and
a radar system formed on the body, the radar system comprising:
an antenna; and
a radome surrounding the antenna, the radome comprising a plurality of transition layers each having a different respective permittivity;
wherein the respective permittivities of each of the transition layers are inversely related to a distance from the respective one of the transition layers to the antenna, generating a permittivity gradient for the radome.

9. The mobile platform of claim 8, wherein the plurality of transition layers are each made of a different dielectric material.

10. The mobile platform of claim 8, wherein:
the radar system comprises a plurality of antennas; and
the plurality of transition layers comprise:
a first transition layer comprising isolating material that is disposed between the plurality of antennas; and
a plurality of additional transition layers surrounding the first transition layer.

11. The mobile platform of claim 10, wherein the plurality of additional transition layers comprise one or more lenses.

12. The mobile platform of claim 10, wherein the plurality of additional transition layers comprise:
an outer transition layer in contact with an outside region that is disposed outside the radome; and
a plurality of intermediate transition layers disposed between the first transition layer and the outer transition layer.

13. The mobile platform of claim 12, wherein:
the outer transition layer comprises a conical lens; and
the plurality of intermediate transition layers comprise one or more flat lenses.

14. The mobile platform of claim 8, wherein the mobile platform comprises a vehicle.

15. The mobile platform of claim 8, wherein the mobile platform comprises an automobile.

16. A method comprising:
obtaining an antenna for a radar system; and
forming a plurality of transition layers surrounding the antenna, forming a radome, with each of the plurality of transition layers having a different respective permittivity, wherein the respective permittivities of each of the transition layers are inversely related to a distance from the respective one of the transition layers to the antenna, generating a permittivity gradient for the radome.

17. The method of claim 16, wherein the forming of the transition layers comprises forming the transition layers via injection molding.

18. The method of claim 16, wherein the forming of the transition layers comprises forming the transition layers via three-dimensional printing.

19. The method of claim 16, wherein the forming of the transition layers comprises forming each of the transition layers with a different dielectric material.

20. The method of claim 19, wherein:
the obtaining of the antenna comprises obtaining a plurality of antennas for the radar system; and
the forming of the plurality of transition layers comprises:
forming a first transition layer comprising isolating material between the plurality of antennas; and
forming a plurality of additional transition layers surrounding the first transition layer.
